(19) United States
(12) Patent Application Publication
(10) Pub. No.: US 2025/0375998 A1
(43) Pub. Date: Dec. 11, 2025

(54) HEAT EXCHANGE DEVICE AND VEHICLE INCLUDING THE SAME

(71) Applicants: HYUNDAI MOTOR COMPANY, Seoul (KR); Kia Corporation, Seoul (KR)

(72) Inventors: Myung Hwan KIM, Hwaseong-si (KR); Min Seong KIM, Hwaseong-si (KR); Eun Sung SHIN, Hwaseong-si (KR); Gab Bae JEON, Hwaseong-si (KR); Hyun Wook PARK, Hwaseong-si (KR)

(21) Appl. No.: 18/955,161

(22) Filed: Nov. 21, 2024

(30) Foreign Application Priority Data
Jun. 10, 2024 (KR) 10-2024-0075241

(51) Int. Cl. B60H 1/00

(52) U.S. Cl. CPC B60H 1/00328

(57) ABSTRACT

A heat exchange device includes a heat exchanger having a passage configured to carry a heat exchange fluid, and an air guide that is provided at one side of the heat exchanger and defines an interior space, where the air guide has a fist side in fluid communication with an outside of the air guide and a second side in fluid communication with the heat exchanger. The air guide further defines an introduction space connecting the outside of the air guide to the interior space, where the introduction space is defined at a lower area of the air guide.

### CROSS-REFERENCE TO RELATED APPLICATION

This application claims the benefit of priority to Korean Application No. 10-2024-0075241, filed in the Korean Patent Intellectual Property Office, on Jun. 10, 2024, the entire contents of which are incorporated herein by reference.

### TECHNICAL FIELD

The present disclosure relates to a heat exchange device and a vehicle including the heat exchange device, and more particularly, to a heat exchange device that may be used in a vehicle, and a vehicle including the heat exchange device.

### BACKGROUND

An electric vehicle may drive wheels, using electric energy from a battery as a power source. In some cases, the electric vehicle may dissipate heat generated from the battery and a motor that drives the wheels. In some cases, to recover heat from a heat emitting part including the battery and the motor and discharge it to an outside, the electric vehicle may include a cooling module. As a demand for design aesthetics of the vehicle increases, researches may be conducted to improve the aesthetics of the vehicle.

In some cases, where the cooling module is mounted on the vehicle, a hole is provided around the cooling module to introduce cooling air. For instance, the hole may be defined in a front area of the vehicle, such as a bumper, to supply air from a front side of the vehicle to the cooling module. In some cases, the hole in front of the vehicle may deteriorate the aesthetics of the vehicle and an overall aerodynamic performance of the vehicle.

### SUMMARY

The present disclosure describe an air guide structure that can improve the aesthetics and aerodynamic performance of a vehicle by effectively cooling parts in the vehicle, even if an air introduction hole is removed from a front area of the vehicle.

According to one aspect of the subject matter described in this present disclosure, a heat exchange device includes a heat exchanger that defines a passage configured to carry a heat exchange fluid, and an air guide that is disposed at a side of the heat exchanger and defines an interior space, where the air guide has a first side in fluid communication with an outside of the air guide and a second side in fluid communication with the heat exchanger. The air guide further defines an introduction space connecting the outside of the air guide and the interior space, where the introduction space is defined at a lower area of the air guide.

Implementations according to this aspect can include one or more of the following features. For example, the air guide may include a first area defining a front side of the air guide, and a second area connected to a rear side of the first area, where at least a portion of the interior space is defined at the second area. A lower end of the second area may be located below a lower end of the first area.

In some implementations, the second area may include an inclined surface that is disposed at a lower section of the second area and inclined upward as the second area extends rearward relative to the rear side of the first area. In some examples, the first area may include an inclined surface that is inclined upward as the first area extends rearward from the front side of the air guide.

In some examples, the air guide may further include a third area that is connected to a rear side of the second area and connects the second area to the heat exchanger, the third area defining at least a portion of the interior space of the air guide. A width of the introduction space in a leftward/rightward direction (W) may be greater than a width of the third area in the leftward/rightward direction (W). In some examples, a width of the third area in an upward/downward direction (H) may be greater than each of widths of the first area and the second area in the upward/downward direction (H).

In some examples, the first area, the second area, and the third area may be separately provided parts of the air guide, where the first area and the second area are fixedly coupled to each other, the second area and the third area are fixedly coupled to each other, and the third area and the heat exchanger are fixedly coupled to each other. In some examples, the first area, the second area, and the third area may be provided integrally.

In some implementations, the introduction space may be opened to a lower side of the air guide. In some examples, the introduction space may be defined at a lower end of the air guide and opened to a front side of the air guide. In some examples, the air guide may include an inclined surface that is disposed at a lower surface section of the air guide, where the inclined surface is inclined upward as the air guide extends rearward relative to the front side of the air guide. In some examples, an entirety of the lower surface section of the air guide may be the inclined surface.

In some implementations, the air guide may further include a horizontal surface that is disposed at the lower surface section of the air guide and extends in a horizontal direction, where the horizontal surface is disposed forward relative to the inclined surface.

In some examples, the introduction space may be opened to a front side of the air guide and a lower side of the air guide.

In some implementations, the heat exchange device may further include a rotator disposed forward relative to the introduction space of the air guide, where at least a portion of the rotator is disposed below a lower side of the air guide.

According to another aspect, a vehicle includes the heat exchange device described above and an under-cover coupled to the lower area of the air guide, where the under-cover defines a through-hole that is in fluid communication with the introduction space of the air guide.

Implementations according to this aspect may include one or more of the features descried above and the following features. For example, the introduction space may be defined at a lower side of the under-cover. In some examples, at least a portion of the air guide may pass through the under-cover and be disposed below a lower side of the under-cover.

In some examples, the heat exchange device may further include a rotator disposed forward relative to the introduction space of the air guide, where at least a portion of the rotator is disposed below a lower side of the air guide.

In some examples, the heat exchange device may be disposed at a front side of the vehicle.

### BRIEF DESCRIPTION OF THE DRAWINGS

The features and advantages of the present disclosure will be more apparent from the following detailed description taken in conjunction with the accompanying drawings.

FIG. 1 is a perspective view showing an example of a heat exchange device.

FIG. 2 is a side view showing an example of a heat exchange device.

FIG. 3 is a drawing illustrating an example of a flow path of air when a vehicle travels while the heat exchange device of FIG. 1 is mounted on a vehicle.

FIG. 4 is a perspective view showing an example of a heat exchange device.

FIG. 5 is a view illustrating a cross-sectional structure of the heat exchange device in FIG. 4, viewed from a lateral side.

FIG. 6 is a perspective view showing an example of a heat exchange device.

FIG. 7 is a view illustrating a cross-sectional structure of the heat exchange device in FIG. 6, viewed from a lateral side.

### DETAILED DESCRIPTION

Hereinafter, a heat exchange device and a vehicle will be described with reference to the drawings.

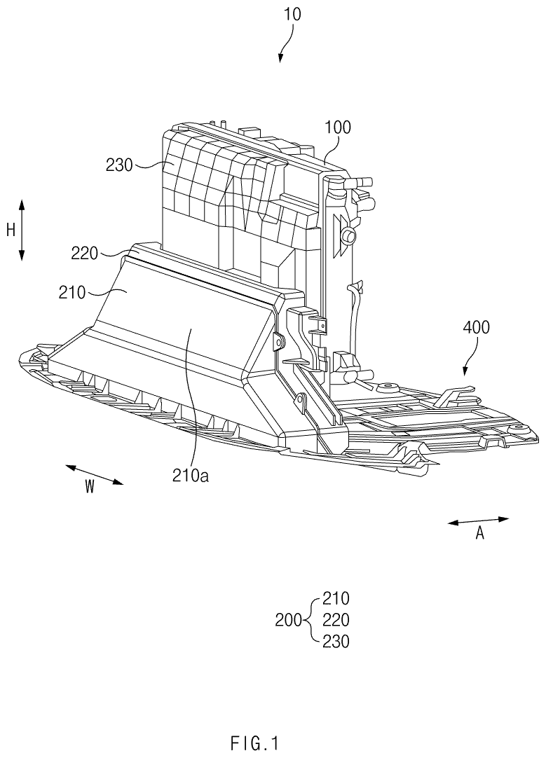

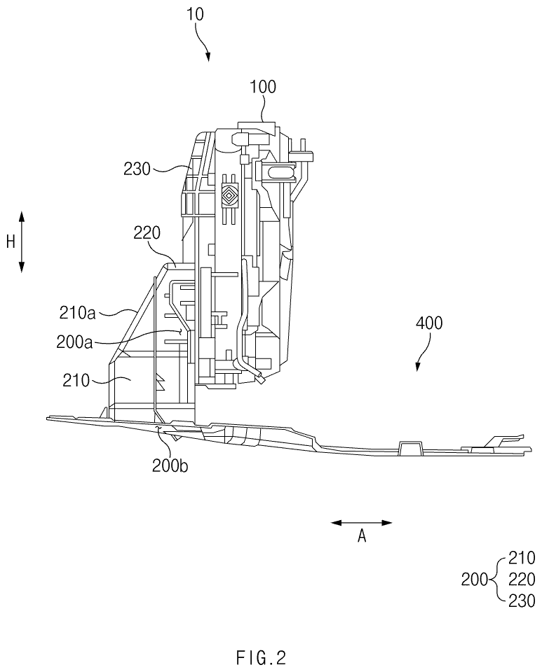

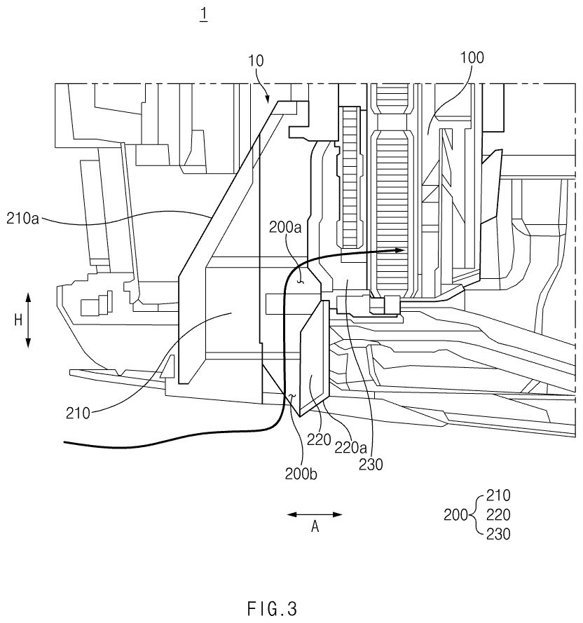

FIG. 1 is a perspective view showing an example of a heat exchange device, and FIG. 2 is a side view of the heat exchange device. FIG. 3 is a drawing illustrating a flow path of air when a vehicle travels while the heat exchange device of FIG. 1 is mounted on a vehicle.

A heat exchange device 10 may be a configuration for cooling a fluid (hereinafter, ‘a heat exchange fluid’) that is introduced into the heat exchange device. In more detail, the heat exchange device 10 may be configured to be mounted on a vehicle 1, and may be configured to cool the heat exchange fluid that recovers heat generated from components in the vehicle 1.

The heat exchange device 10 may be an air-cooling heat exchange device 10 that receives air from an outside and cools the heat exchange fluid by exchanging heat between the air and the heat exchange fluid.

In some implementations, referring to FIGS. 1 to 3, the heat exchange device 1 may include a heat exchanger 100 that defines a passage configured to the heat exchange fluid, and an air guide 200 that is provided at one side of the heat exchanger 100 and defines an interior space 200a, where the air guide 20 may have a first side in fluid communication with the outside of the air guide 20, and a second side in fluid communication with the heat exchanger 100. The interior space 200a of the air guide 200 may form a passage, through which the air supplied from the outside flows. For example, the air introduced into the interior space 200a of the air guide 200 from the outside may be introduced into the heat exchanger 100. The heat exchanger 100 may be a closed heat exchanger. In some examples, as illustrated in FIGS. 1 to 3, the heat exchanger 100 may be fixedly coupled to a rear area of the air guide 200.

In some examples, an introduction space 200b that connects the outside of the air guide 200 and the interior space 200a may be formed in the air guide 200. For instance, the exterior air may be supplied to the interior space 200a through the introduction space 200b. In some examples, the introduction space 200b may be formed in a lower area of the air guide 200. Referring to FIGS. 1 to 4, it may be understood that the air guide 200 has a shape that is opened to a lower side. Accordingly, in the heat exchange device 10, the air may be supplied to the interior space 200a of the air guide 200 through the lower area of the air guide 200.

According to the above-described contents of the present disclosure, because the exterior air may be smoothly supplied to the heat exchange device 10 without forming a separate hole for introducing the exterior air into a front configuration (for example, a bumper of the vehicle) of the vehicle 1, on which the heat exchange device 10 is mounted, a cooling performance of the vehicle 1 may be maintained or improved without damaging the aesthetics of the vehicle 1.

In some examples, the air guide 200 may be divided into a plurality of areas.

In more detail, the air guide 200 may include a first area 210 that defines a front area of the air guide 200 and is configured such that at least a portion thereof faces a rotator 300 in an upward/downward direction “H,” a second area 220 that is connected to a rear side of the first area 210, and in which at least a portion of the interior space 200a is formed, and a third area 230 that is connected to a rear side of the second area 220, connects the second area 220 and the heat exchanger 100, and defines at least a portion of the interior space 200a. In some examples, the first area 210, the second area 220, and the third area 230 described above may be provided as separate parts, and the first area 210 and the second area 220 may be fixedly coupled to each other, the second area 220 and the third area 230 may be fixedly coupled to each other, and the third area 230 and the heat exchanger 100 may be fixedly coupled to each other. On the other hand, according to another example of the present disclosure, the first area 210, the second area 220, and the third area 230 may be formed integrally.

In some examples, the introduction space 200b described above may be opened to a lower side. For example, the air guide 200 may have a shape that may guide the exterior air into the interior space 200a to maximize an amount of the exterior air that is introduced into the interior space 200a through the introduction space 200b.

In more detail, referring to FIGS. 1 to 3, a lower end of the second area 220 may be located on a lower side of a lower end of the first area 210. The reason why the lower end of the second area 220 is located on a lower side of the lower end of the first area 210 may be to maximize an amount of the exterior air that is introduced into the interior space 200a through the introduction space 200b.

In some implementations, as illustrated in FIGS. 1 to 3, a rear surface of a lower section of the second area 220 of the air guide 200 may include an inclined surface 220a that is located on a rear side as it goes upward. In this case, the exterior air may be effectively introduced into the interior space 200a via the introduction space 200b as it is guided by the inclined surface 220a of the second area 220.

In some implementations, a front section of the first area 210 may include an inclined surface 210a that is located on an upper side when it goes to the rear side. The inclined surface 210a of the first area 210 may be a configuration that defines a front end of the interior space 200a so that the air introduced into the interior space 200a may be smoothly supplied to the heat exchanger 100.

In some implementations, the introduction space 200b may be formed in lower areas of the first area 210 and the second area 220. In some examples, a width of the introduction space 200b in a leftward/rightward direction “W” may be greater than a width of the third area 230 in the leftward/rightward direction “W.” This width configuration may maximize the amount of the exterior air guided through the rotation of the rotator 300, which is to be introduced into the interior space 200a, by increasing a size of the introduction space 200b. For example, a width of the introduction space 200b in the leftward/rightward direction “W” may be 16% or more greater than widths of the third area 230 and the heat exchanger 100 in the leftward/rightward direction “W.”

In some examples, the air guide 200 may have a shape, of which an overall width in upward/downward direction “H” increases as it goes toward the rear side, that is, as it becomes closer to the heat exchanger 100. For example, referring to the drawing, a width of the third area 230 in the upward/downward direction “H” may be greater than widths of the first area 210 and the second area 220 in the upward/downward direction “H.” In some examples, the widths of the third area 230 in the upward/downward direction “H” and the leftward/rightward direction “W” may correspond to the widths of the heat exchanger 100 in the upward/downward direction “H” and the leftward/rightward direction “W,” respectively. In this case, the exterior air introduced into the interior space 200a may be uniformly supplied to the heat exchanger 100 as a whole.

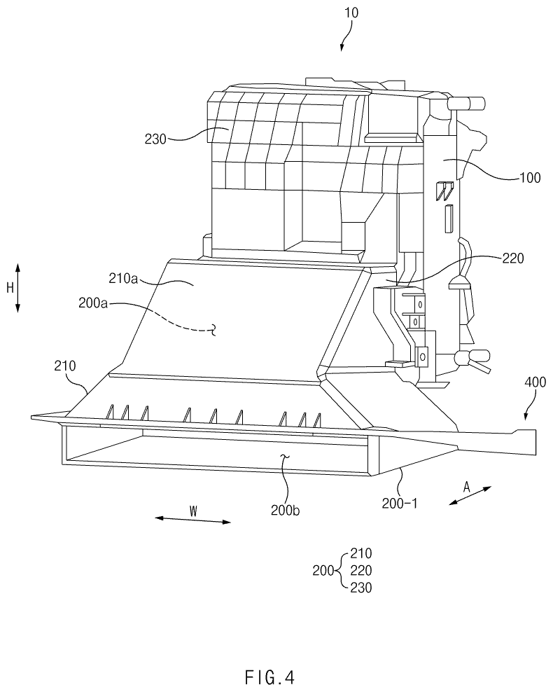

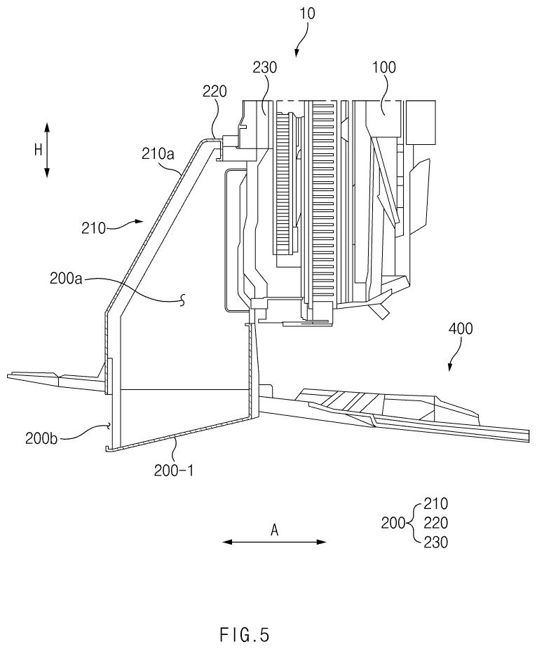

FIG. 4 is a perspective view showing an example of a heat exchange device, and FIG. 5 is a view illustrating a cross-sectional structure of the heat exchange device according to FIG. 4, when viewed from a lateral side.

Compared to the heat exchange devices illustrated in FIGS. 1 to 3, the heat exchange device 10 illustrated in FIGS. 4 and 5 is different in a side surface in the direction, in which the introduction space 200b is opened.

In more detail, referring to FIGS. 4 and 5, the introduction space 200b formed in the air guide 200 may be formed at a lower end of the air guide 200, and may be opened to a front side. In this case, compared to the heat exchange device 10 illustrated in FIGS. 1 to 3, the driving wind generated in a driving situation of a vehicle, on which the heat exchange device 10 is mounted, may be more smoothly introduced into the introduction space 200b.

In some implementations, a lower surface section of the air guide 200 may include an inclined surface 200-1 that is located on an upper side as it goes to the rear side. In some examples, the inclined surface 200-1 may provide a function that is similar to that of the inclined surface 220a of the second area 220. That is, the inclined surface 200-1 may also perform a function of guiding the exterior air more effectively and supplying it to the interior space 200a via the introduction space 200b. As an example, FIGS. 4 and 5 illustrate a state, in which the inclined surface 200-1 described above is formed in the entire lower surface section of the air guide 200. In some examples, the lower surface section of the air guide 200 may be understood as the lower surface of the first area 210 and the lower surface of the second area 220, and because the third area 230 is located on an upper side of the first area 210 and the second area 220, the inclined surface 200-1 described above may not be formed in the third area 230. In some examples, except for the above-described contents, a description of the contents of the heat exchange device 10 are replaced with the description of the heat exchange device 10, which has been made above with reference to FIGS. 1 to 3.

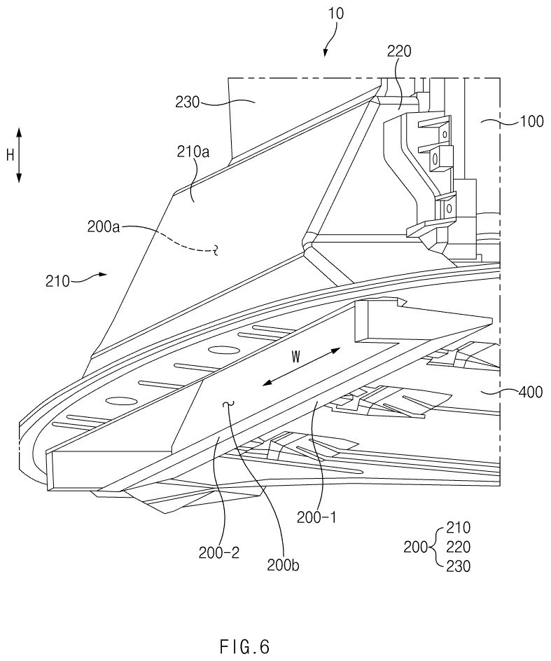

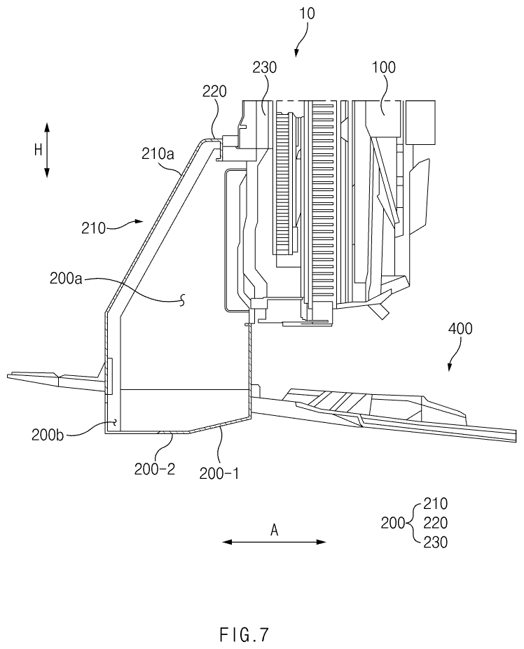

FIG. 6 is a perspective view showing an example of a heat exchange device, and FIG. 7 is a view illustrating a cross-sectional structure of the heat exchange device according to FIG. 6, when viewed from a lateral side.

Compared to the heat exchange devices illustrated in FIGS. 4 to 5, the heat exchange device 10 illustrated in FIGS. 6 and 7 is different in a side surface in the direction, in which the introduction space 200b is opened.

In more detail, referring to FIGS. 6 and 7, the introduction space 200b formed in the air guide 200 may be formed at a lower end of the air guide 200, and may be opened to a front side and a lower side together. In this case, all the advantages of the introduction space 200b may be secured.

In some implementations, the lower surface section of the air guide 200 may further include a horizontal surface 200-2 that extends in the horizontal direction, in addition to the inclined surface 200-1 that is located on an upper side as it goes to the rear side. For example, the horizontal surface 200-2 described above may be provided on a front side of the inclined surface 200-1. Except for the above-described contents, a description of the contents of the heat exchange device 10 is replaced with the description of the heat exchange device 10, which has been made above with reference to FIGS. 1 to 3.

In some implementations, the vehicle 1 may include the heat exchange device 10, and an under-cover 400 that is connected to the lower area of the air guide 200 that is provided in the heat exchange device 10 and substantially has a plate shape. The under-cover 400 may be a configuration that defines a lower surface of the vehicle 1. As illustrated in FIG. 4, and the like, the under-cover 400 may be fixedly coupled to the lower areas of the first area 210 and the second area 220, and may be spaced apart from the third area 230 in the upward/downward direction “H.”

In some examples, a through-hole that is communicated with the introduction space 200b may be formed in the under-cover 400. The through-hole formed in the under-cover 400 may serve as a path so that the exterior air may be introduced into the interior space 200a via the introduction space 200b. In some examples, referring to FIGS. 4 to 7, the introduction space 200b may be formed on a lower side of the under-cover 400. In this case, the air guide 200 may be supplied with the exterior air more smoothly without being obstructed by the under-cover 400. The contents regarding the heat exchange device 10 of the vehicle 1 are replaced with the contents regarding the heat exchange device 10.

In some implementations, the aesthetics and aerodynamic performance of a vehicle may be improved by effectively cooling parts in the vehicle even after a hole formed in a front area of the vehicle is removed.

Although the present disclosure has been described with reference to the implementations, it will be appreciated by an ordinary skilled in the art, to which the present disclosure pertains, that the present disclosure may be modified and changed within the scope of the appended claims without departing from the spirits and technical field of the present disclosure.

What is claimed is:

1. A heat exchange device comprising:
a heat exchanger that defines a passage configured to carry a heat exchange fluid; and
an air guide that is disposed at a side of the heat exchanger and defines an interior space therein, the air guide having (i) a first side in fluid communication with an outside of the air guide and (ii) a second side in fluid communication with the heat exchanger,
wherein the air guide further defines an introduction space at a lower area thereof, the introduction space connecting the outside of the air guide to the interior space.

2. The heat exchange device of claim 1, wherein the air guide includes:
a first area defining a front side of the air guide; and
a second area connected to a rear side of the first area, wherein at least a portion of the interior space is defined at the second area, and
wherein a lower end of the second area is located below a lower end of the first area.

3. The heat exchange device of claim 2, wherein the second area includes an inclined surface that is disposed at a lower section of the second area and inclined upward as the second area extends rearward relative to the rear side of the first area.

4. The heat exchange device of claim 2, wherein the first area includes an inclined surface that is inclined upward as the first area extends rearward from the front side of the air guide.

5. The heat exchange device of claim 2, wherein the air guide further includes:
a third area that is connected to a rear side of the second area and connects the second area to the heat exchanger, the third area defining at least a portion of the interior space of the air guide, and
wherein a width of the introduction space in a leftward/rightward direction (W) is greater than a width of the third area in the leftward/rightward direction (W).

6. The heat exchange device of claim 5, wherein a width of the third area in an upward/downward direction (H) is greater than each of widths of the first area and the second area in the upward/downward direction (H).

7. The heat exchange device of claim 5, wherein the first area, the second area, and the third area are separately provided parts of the air guide,
wherein the first area and the second area are fixedly coupled to each other,
wherein the second area and the third area are fixedly coupled to each other, and
wherein the third area and the heat exchanger are fixedly coupled to each other.

8. The heat exchange device of claim 5, wherein the first area, the second area, and the third area are provided integrally.

9. The heat exchange device of claim 1, wherein the introduction space is opened to a lower side of the air guide.

10. The heat exchange device of claim 1, wherein the introduction space is defined at a lower end of the air guide and opened to a front side of the air guide.

11. The heat exchange device of claim 10, wherein the air guide includes an inclined surface that is disposed at a lower surface section of the air guide, the inclined surface being inclined upward as the air guide extends rearward relative to the front side of the air guide.

12. The heat exchange device of claim 11, wherein an entirety of the lower surface section of the air guide is the inclined surface.

13. The heat exchange device of claim 11, wherein the air guide further includes a horizontal surface that is disposed at the lower surface section of the air guide and extends in a horizontal direction, the horizontal surface being disposed forward relative to the inclined surface.

14. The heat exchange device of claim 1, wherein the introduction space is opened to a front side of the air guide and a lower side of the air guide.

15. The heat exchange device of claim 1, further comprising a rotator disposed forward relative to the introduction space of the air guide,
wherein at least a portion of the rotator is disposed below a lower side of the air guide.

16. A vehicle comprising:
the heat exchange device of claim 1; and
an under-cover coupled to the lower area of the air guide,
wherein the under-cover defines a through-hole that is in fluid communication with the introduction space of the air guide.

17. The vehicle of claim 16, wherein the introduction space is defined at a lower side of the under-cover.

18. The vehicle of claim 16, wherein at least a portion of the air guide passes through the under-cover and is disposed below a lower side of the under-cover.

19. The vehicle of claim 16, wherein the heat exchange device further comprises a rotator disposed forward relative to the introduction space of the air guide, and
wherein at least a portion of the rotator is disposed below a lower side of the air guide.

20. The vehicle of claim 16, wherein the heat exchange device is disposed at a front side of the vehicle.
